(19) United States
(12) Patent Application Publication
(10) Pub. No.: US 2008/0043010 A1
(43) Pub. Date: Feb. 21, 2008

(54) Driving Circuit and Method for Data Drivers in a Bi-Stable Display

(75) Inventors: Hjalmar E.A. Huitema, Veldhoven (NL); Guofu Zhou, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,020

(22) PCT Filed: Nov. 14, 2005
(86) PCT No.: PCT/IB05/53744

§ 371 Date: May 10, 2007

Related U.S. Application Data
(60) Provisional application No. 60/628,681, filed on Nov. 17, 2004.

(51) Int. Cl. G09G 3/34

(52) U.S. Cl. 345/212

(57) ABSTRACT

A display employs an arrangement of a matrix of pixels (30), and a column driving circuit (10) including an array of fixed level data drivers (30) for generating a drive waveform that is applied to the matrix of pixels (30) during an image update period. A power supply (V_{PS}) for each fixed level data driver (11) is set to a base voltage (V₀) during a first phase (P1) of a driving portion (DP) of the image update period, and the power supply (V_{PS}) of each fixed level data driver (11) is switched from the base voltage (V₀) to a transitional voltage (V₁) in response to a transition from the first phase (P1) of the driving portion (DP) to a second phase (P2) of the driving portion (DP). The base voltage (V₀) will either be less than or greater than the transitional voltage (V₁).

The present invention generally relates to various methods for driving a bi-stable display during an image update period. The present invention specifically relates to a method for increasing the number of data voltage levels of a fixed level data driver during an image update period.

A 3-level data driver (i.e., V_{LOW}, 0 volts, and V_{HIGH}) is typically used in a bi-stable display (e.g., an electrophoretic display). To achieve more accurate grayscales/color scales and to increase a number of transitional gray levels/color levels in a black and white display/color display, it has been proposed to replace the 3-level data drivers with data drivers having additional voltage levels. However, the cost of a data driver exponentially increases with the number of voltage levels for the data driver. The display industry is therefore continually striving to achieve more accurate grayscales/color scales and to increase a number of transitional gray levels/color levels in a black and white display/color display while minimizing the costs of the data drivers. To this end, the present invention provides new and unique method and display for increasing the number of data voltage levels of a fixed level data driver during an image update period.

One form of the present invention is a method for generating an increased number of voltage levels of a fixed level data driver during a driving portion of an image update period of a bi-stable display. The method involves a setting a power supply of the fixed level data driver to a base voltage during a first phase of the driving portion, and a switching the power supply of the fixed level data driver from the base voltage to a transitional voltage in response to a transition from the first phase of the driving portion to a second phase of the driving portion. The base voltage will either be less than or greater than the transitional voltage.

A second form is a display employs an arrangement of a matrix of pixels, and a column driving circuit including an array of fixed level data drivers or generating a drive waveform that is applied to the matrix of pixels during an image update period. A power supply for each fixed level data driver is set to a base voltage during a first phase of a driving portion of the image update period, and the power supply of each fixed level data driver is switched from the base voltage to a transitional voltage in response to a transition from the first phase of the driving portion to a second phase of the driving portion. The base voltage will either be less than or greater than the transitional voltage.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

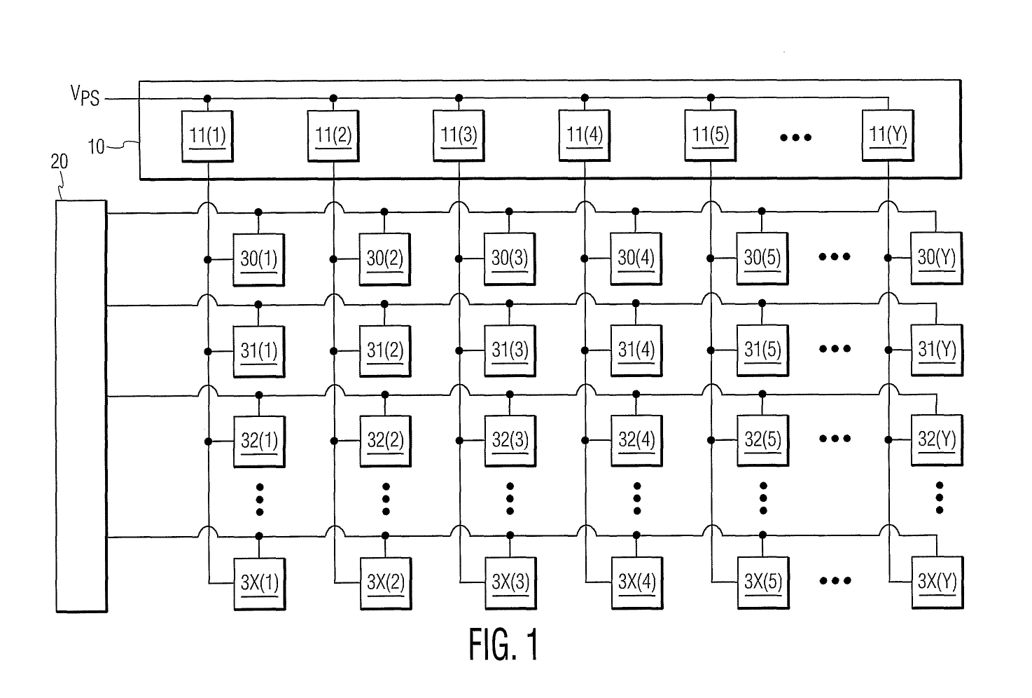

FIG. 1 illustrates an exemplary embodiment of a bi-stable display in accordance with the present invention;

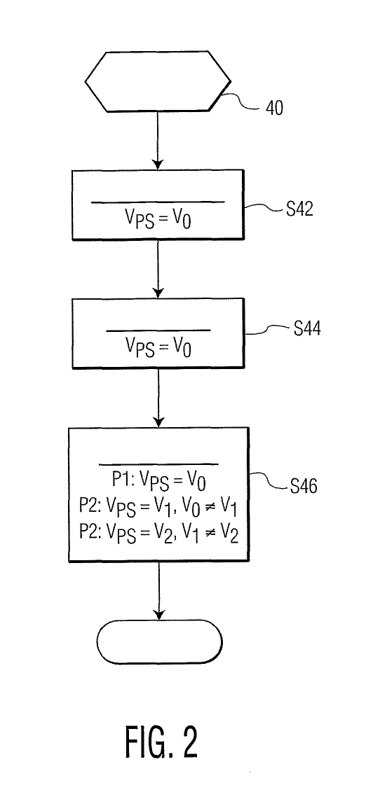

FIG. 2 illustrates a flowchart illustrative of an image update period method in accordance with the present invention;

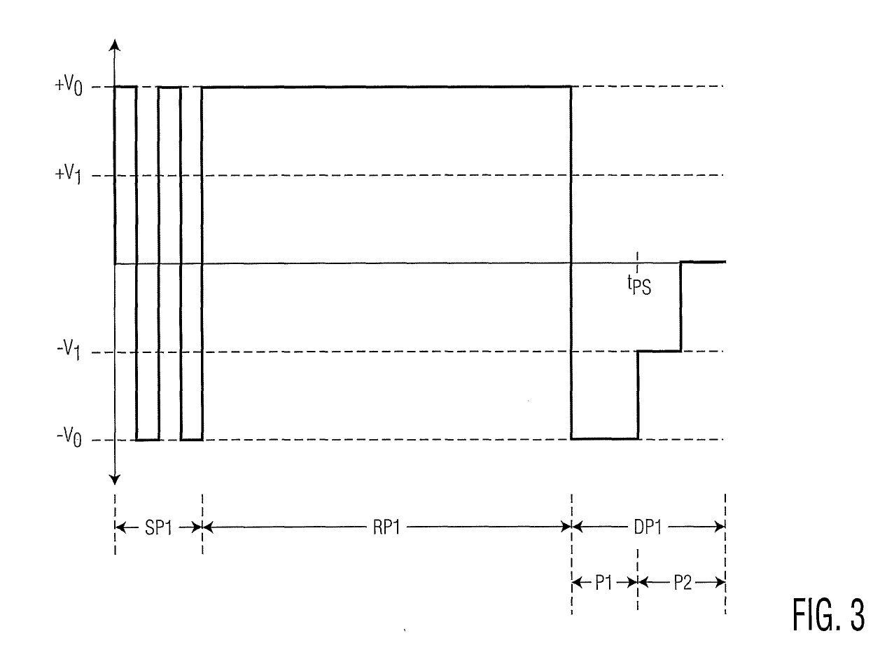

FIG. 3 illustrates an exemplary drive waveform for a white (W) to a dark grey (DG) transition during an image update period in accordance with the present invention;

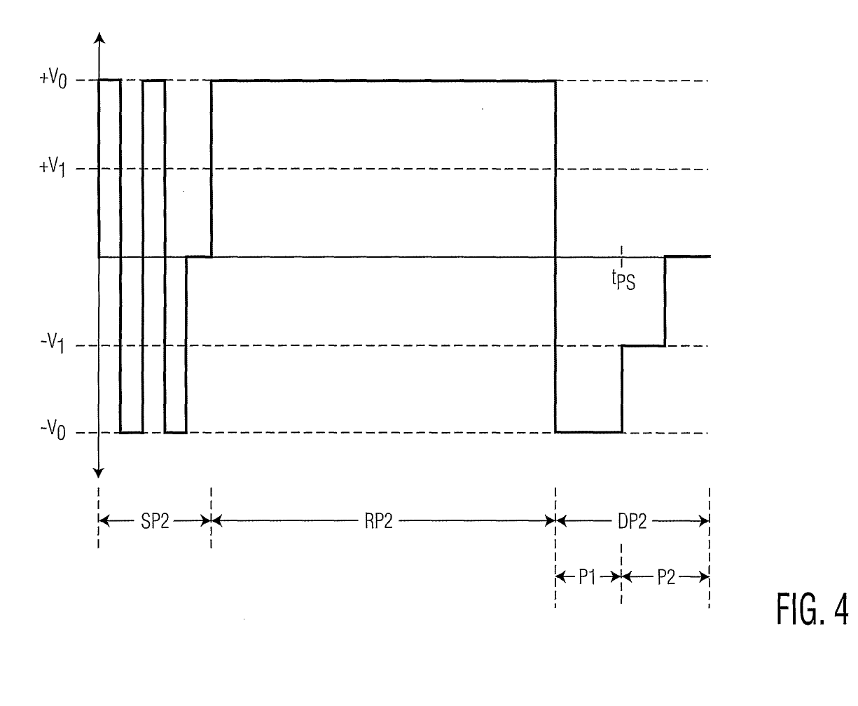

FIG. 4 illustrates an exemplary drive waveform for a light grey (LG) to a dark grey (DG) transition during an image update period in accordance with the present invention; and

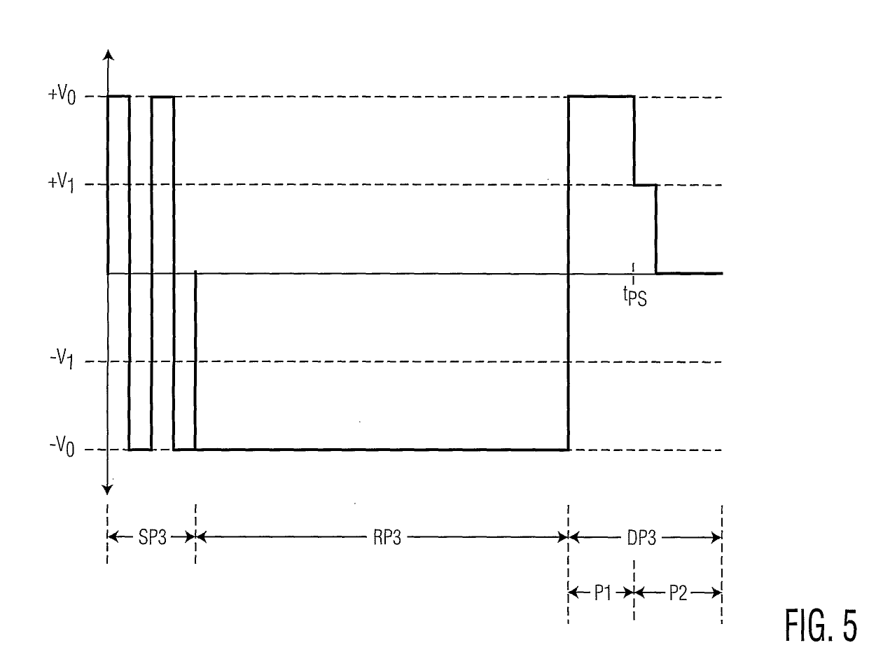

FIG. 5 illustrates an exemplary drive waveform for a dark grey (DG) to black (B) transition during an image update period in accordance with the present invention.

A bi-stable display illustrated in FIG. 1 employs a conventional arrangement of a column driving circuit 10, a row addressing circuit 20, and a matrix of pixels 30(1)-3X(Y), where X≧1 and Y≧1. Column driving circuit 10 employs an array of fixed level data drivers 11(1)-11(Y) connected to a power supply V_{PS}. The bi-stable display is minimally illustrated in FIG. 1 facilitate a description of a image update period method of the present invention as illustrated in FIGS. 2-5. Nonetheless, those having ordinary skill in the art will appreciate a complete configuration of a bi-stable display when practicing the present invention.

A flowchart 40 as illustrated in FIG. 2 implements an image update period method of the present invention for increasing a number of data voltage levels of a fixed level data drivers 11(1)-11(Y) during an image update period. For purposes of teaching FIG. 2, data drivers 11(1)-11(Y) will be described as 3-level data drivers.

A stage S42 of flowchart 40 involves a conventional generation of shaking pulses during an image update period where power supply V_{PS} is set to base voltage V₀. FIG. 3 exemplary illustrates a generation of shaking pulses in a shaking portion SP1 of the image update period for a white to a dark grey transition. FIG. 4 exemplary illustrates a generation of shaking pulses in a shaking portion SP2 of the image update period for a light grey to a dark grey transition. FIG. 5 exemplary illustrates a generation of shaking pulses in a shaking portion SP3 of the image update period for a dark grey to a light grey transition.

Referring again to FIG. 2, a stage S44 of flowchart 40 involves a conventional generation of reset pulses during an image update period where power supply V_{PS} is set to base voltage V₀. FIG. 3 exemplary illustrates a generation of a reset pulse in a reset portion RP1 of the image update period for a white to a dark grey transition. FIG. 4 exemplary illustrates a generation of a reset pulse in a reset portion RP2 of the image update period for a light grey to a dark grey transition. FIG. 5 exemplary illustrates a generation of a reset pulse in a reset portion RP3 of the image update period for a dark grey to a light grey transition.

Referring again to FIG. 2, a stage S46 of flowchart 40 involves a conventional generation of a driving pulse during an image update period where the driving pulse is divided into two or more phases. For a first phase P1, power supply V_{PS} is set to base voltage V₀. For a second phase P2, power supply V_{PS} is switched from base voltage V₀ to a transitional voltage V₁ that is unequal to base voltage V₀ (i.e., transitional voltage V₁ is either less than or greater than base voltage V₀). For an optional third phase P3, power supply V_{PS} is switched from transitional voltage V₁ to an additional transitional voltage V₂ that is unequal to transitional voltage V₁ (i.e., transitional voltage V₂ is either less than or greater than transitional voltage V₁). In one embodiment, an absolute value of base voltage V_{O} is greater than an absolute voltage of transitional voltage V₁, which is greater than an absolute voltage of transitional voltage V₂.

FIG. 3 exemplary illustrates a generation of a driving pulse in a driving portion SP1 the image update period for a white to a dark grey transition where driving portion SP1 transitions from the first phase P1 to the second phase P2 as a power supply switch time t_{PS}. FIG. 4 exemplary illustrates a generation of driving pulses in a driving portion SP2 of the image update period for a light grey to a dark grey transition where driving portion SP2 transitions from the first phase P1 to the second phase P2 as a power supply switch time t_{PS}. FIG. 5 exemplary illustrates a generation of shake pulses in a driving portion SP3 of the image update period for a dark grey to a light grey transition where driving portion SP3 transitions from the first phase P1 to the second phase P2 as a power supply switch time t_{PS}.

Referring again to FIG. 2, in one embodiment, all of the base voltage V_{O}, the transitional voltage V₁ and the transitional voltage V₂ are fixed for each driving portion of an image update period. In an alternative embodiment, the base voltage V_{O}, the transitional voltage V₁ and/or the transitional voltage V₂ can be varied in between driving portions of an image update period.

Furthermore, stage S42 and/or stage S44 may be omitted in dependent of the type of display for which the present invention is being practiced.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of generating an increased number of voltage levels of a fixed level data driver (11) during a driving portion of an image update period of a bi-stable display, the method comprising:
setting a power supply (V_{PS}) of the fixed level data driver (11) to a base voltage (V₀) during a first phase (P1) of the driving portion (DP); and
switching the power supply (V_{PS}) of the fixed level data driver (11) from the base voltage (V₀) to a first transitional voltage (V₁) in response to a transition from the first phase (P1) of the driving portion (DP) to a second phase (P2) of the driving portion (DP),
wherein the base voltage (V₀) and the first transitional voltage (V₁) are unequal.

2. The method of claim 1, wherein an absolute value of the base voltage (V₀) is greater than an absolute value of the first transitional voltage (V₁).

3. The method of claim 1, further comprising:
switching the power supply (V_{PS}) of the fixed level data driver (11) from the first transitional voltage (V₁) to a second transitional voltage (V₂) in response to a transition from the second phase (P2) of the driving portion (DP) to a third phase (P3) of the driving portion (DP),
wherein the base voltage (V₀), the first transitional voltage (V₁) and the second transitional voltage (V₂) are unequal.

4. The method of claim 3,
wherein an absolute value of the base voltage (V₀) is greater than an absolute value of the first transitional voltage (V₁); and
wherein the absolute value of the first transitional voltage (V₁) is greater than an absolute value of the second transitional voltage (V₂).

5. A method of generating an increased number of voltage levels of a fixed level data driver (11) during an image update period of a bi-stable display, the method comprising:
setting a power supply (V_{PS}) of the fixed level data driver (11) to a base voltage (V₀) during at least one of a shaking portion (SP) of the image update period and a reset portion (RP) of the image update period; and
switching the power supply (V_{PS}) of the fixed level data driver (11) from the base voltage (V₀) to a first transitional voltage (V₁) during a driving portion (DP) of the image update period,
wherein the base voltage (V₀) and the first transitional voltage (V₁) are unequal.

6. The method of claim 5, wherein an absolute value of the base voltage (V₀) is greater than an absolute value of the first transitional voltage (V₁).

7. The method of claim 5, further comprising:
switching the power supply (V_{PS}) of the fixed level data driver (11) from the first transitional voltage (V₁) to a second transitional voltage (V₂) during the driving portion (DP) of the image update period,
wherein the base voltage (V₀), the first transitional voltage (V₁) and the second transitional voltage (V₂) are unequal.

8. The method of claim 7,
wherein an absolute value of the base voltage (V₀) is greater than an absolute value of the first transitional voltage (V₁); and
wherein the absolute value of the first transitional voltage (V₁) is greater than an absolute value of the second transitional voltage (V₂).

9. A display, comprising:
a matrix of pixels (30); and
a column driving circuit (10) including an array of fixed level data drivers (30) for generating a drive waveform that is applied to the matrix of pixels (30) during an image update period,
wherein a power supply (V_{PS}) for each fixed level data driver (11) is set to a base voltage (V₀) during a first phase (P1) of a driving portion (DP) of the image update period,
wherein the power supply (V_{PS}) of each fixed level data driver (11) is switched from the base voltage (V₀) to a first transitional voltage (V₁) in response to a transition from the first phase (P1) of the driving portion (DP) to a second phase (P2) of the driving portion (DP), and
wherein the base voltage (V₀) and the first transitional voltage (V₁) are unequal.

10. The display of claim 9, wherein an absolute value of the base voltage (V₀) is greater than an absolute value of the first transitional voltage (V₁).

11. The display of claim 9,
wherein the power supply (V_{PS}) of the fixed level data driver (11) is switched from the first transitional voltage (V₁) to a second transitional voltage (V₂) in response to a transition from the second phase (P2) of the driving portion (DP) to a third phase (P3) of the driving portion (DP); and
wherein the base voltage (V₀), the first transitional voltage (V₁) and the second transitional voltage (V₂) are unequal.

12. The display of claim 11,
wherein an absolute value of the base voltage (V₀) is greater than an absolute value of the first transitional voltage (V₁); and
wherein the absolute value of the first transitional voltage (V₁) is greater than an absolute value of the second transitional voltage (V₂).

13. A display, comprising:
a matrix of pixels (30); and
a column driving circuit (10) including an array of fixed level data drivers (30) for generating a drive waveform that is applied to the matrix of pixels (30) during an image update period,
wherein a power supply (V_{PS}) of the fixed level data driver (11) is set to a base voltage (V₀) during at least one of a shaking portion (SP) of the image update period and a reset portion (RP) of the image update period,
wherein the power supply (V_{PS}) of the fixed level data driver (11) is switched from the base voltage (V₀) to a first transitional voltage (V₁) during a driving portion (DP) of the image update period, and
wherein the base voltage (V₀) and the first transitional voltage (V₁) are unequal.

14. The display of claim 13, wherein an absolute value of the base voltage (V₀) is greater than an absolute value of the first transitional voltage (V₁).

15. The display of claim 13,
wherein the power supply (V_{PS}) of the fixed level data driver (11) is switched from the first transitional voltage (V₁) to a second transitional voltage (V₂) during the driving portion (DP) of the image update period; and
wherein the base voltage (V₀), the first transitional voltage (V₁) and the second transitional voltage (V₂) are unequal.

16. The display of claim 15,
wherein an absolute value of the base voltage (V₀) is greater than an absolute value of the first transitional voltage (V₁); and
wherein the absolute value of the first transitional voltage (V₁) is greater than an absolute value of the second transitional voltage (V₂).
